(19) United States
(12) Patent Application Publication
(10) Pub. No.: US 2011/0238597 A1
(43) Pub. Date: Sep. 29, 2011

(54) Value builder method

(76) Inventor: Zachariah P. Lamoreaux, Burlington, VT (US)

(21) Appl. No.: 12/661,739

(22) Filed: Mar. 23, 2010

(51) Int. Cl. G06Q 90/00

(52) U.S. Cl. 705/500

(57) ABSTRACT

Value Builder Method is a means for preserving principal within retirement, healthcare, education, savings, or other financial accounts to maximize the investment by paying for fees, taxes, and other miscellaneous expenses with separate funds from an outside source or account(s). Many accounts that provide, financial, education, retirement, investment and/or health savings are limited in how much an individual or group can contribute within a year. The amount that can be contributed within a year is a limited resource. Associated fees, taxes, and costs for an account(s) divert investment funds from the primary purpose of the account(s). Value Builder Method saves money within primary account now as well as earning compounded interest in the future.

### BACKGROUND

1. Field of Invention

A business method that relates to maintaining and retaining the value within retirement, healthcare savings accounts, education and other financial accounts.

2. Prior Art

Individual Retirement Accounts, Roth Individual Retirement Accounts, Solo 401 Retirement, 401 Retirement Accounts, Roth Solo 401K, Roth 401 Retirement Accounts, 403B Accounts, Keogh pension plans, 529 Education accounts, Sep Individual Retirement Accounts, Simple Individual Retirement Accounts, and other retirement accounts, Health Savings Accounts, education savings, Money Market, checking, investment, savings, and other financial accounts charge fees, taxes, maintenance costs, trading costs, trading taxes and other expenses related to the maintenance and management of these types of accounts. The fees and expenses are disbursed from the money contained within the account(s). The value of the account(s) is reduced by deducting fees, taxes, expenses, and other costs from the account(s).

Associated fees, taxes, costs, management costs & maintenance for the account(s) divert investment funds from the primary purpose of the account(s). All investment healthcare, savings, education, financial and retirement accounts use monies contained from within the account(s) to pay for expenses, taxes, fees, therefore depleting principal. The depleted principal will be denied the opportunity of earning interest both now and compounded over time. Expenses have a large negative impact on the compounded interest within the account(s), over time. Many accounts that provide education, retirement, investment and/or health savings are limited in how much an individual can contribute within a year. The amount that can be contributed within any year is a limited resource.

In investment accounts, fees are charged for trading stocks, bonds, mutual funds, Exchange Traded Funds (ETF) and other investments. These fees are extracted from the account(s) thereby reducing the value of the account(s) over time.

Taxes are also applied to the trading of investment, retirement, education, and savings accounts, further limiting the effect of the total maximum amount to be used for its intended purpose. Value Builder Method is an alternative means to pay fees, taxes, and expenses for a primary account(s), while maintaining the fluidity of the primary account(s).

Additional fees are also removed from the ETF, and mutual funds for maintenance purposes. These asset classes could have the internal fees paid for from an external account or means, and the trading fees, taxes, and other costs paid for, through use of the Value Builder Method.

Most personal, financial, education, retirement, health savings and/or investment accounts have a maximum contribution amount per year. Associated fees and costs reduce the amount available for the intended purpose of the account, thus reducing the options of an individual(s) who owns the account(s). An individual's options are reduced, by having the accounts' principal reduced by trades, taxes, fees, and other expenses. Since there is limited input per year, the fees limit the individuals' options over the long term as well as in the short term.

### SUMMARY

Value Builder Method is a means for preserving principal within retirement, healthcare, education or other financial accounts to maximize the investment by paying for fees, taxes and other miscellaneous expenses with separate funds from an outside source or account(s). Value Builder Method works in tandem with, but not limited to, Individual Retirement Accounts, Roth Individual Retirement Accounts, Solo 401 Retirement, 401 Retirement Accounts, Roth Solo 401K, Roth 401 Retirement Accounts, 403B Accounts, Keogh pension plans, Sep Individual Retirement Account, 529 Education accounts, Simple Individual Retirement Account, and other retirement accounts, Health Savings Accounts, education savings, Money Market, checking, investment, savings, and other financial accounts and offers a convenient method of payment established for the purpose of paying for fees, taxes and other costs without reducing the value of the account(s). Giving individuals an option, for paying for fees, services, taxes or other financial expenses from an outside source, would ease the burden of maintaining the fluidity of money within the account(s). Money would be saved within the primary account(s) now as well as earning compounded interest in the future.

Individual investors do not always have control over the amount of interest earned within Retirement, health, education, savings, and investment accounts. Investors would have the ability to control and maintain how the expenses, fees, and taxes are paid, through use of Value Builder Method. Account expenses might otherwise deplete the account(s). Value Builder Method leaves the account more independent of what the financial markets are doing.

### DETAILED DESCRIPTION-FIG. 1—PREFERRED EMBODIMENT

The preferred method of Value Builder Method is to establish a means of payment for the fees, expenses, taxes, and other costs for retirement, education, health, and investment account or a plurality of accounts that may have a limited maximum allowable contribution per year. Accounts that match this profile include but are not limited to Individual Retirement Accounts, Roth Individual Retirement Accounts, Solo 401 Retirement, 401 Retirement Accounts, Roth Solo 401K, Roth 401 Retirement Accounts, 403B Accounts, Keogh pension plans, Sep Individual Retirement Accounts, 529 Education accounts, Simple Individual Retirement Accounts, and other retirement accounts, Health Savings Accounts, Money Market, Checking, Savings, and other financial accounts. The use of Value Builder Method, allows for the maximum attainable value of the accounts to be available to individuals, for a specific or non-specific goal. Individuals that did not deposit the maximum amount for the year would be able to invest or spend all of the deposit that was made, leaving room for future deposits later in the year. Funds from an account, singular means or a plurality of means, such as; cash, debit, credit card, wire or electronic transfer, money order, check, are used to pay any account fees, taxes, maintenance fees, transfer fees and other associated expenses for the benefit of the primary account or plurality of primary accounts. This would allow for easy maintenance and tracking of expenses, taxes, and fees, while retaining the maximum principal within the primary account or plurality of accounts.

Account holders will maintain more value within the account(s). Allowing for a more active use of the accounts through the Value Builder Method. No matter how many maintenance fees, expenses, costs, taxes, or other associated fees that are accrued in association with the investment, retirement and health savings accounts, the overall value of the primary account would not be depleted, allowing for more fluid use of the investment, retirement, and health savings accounts.

### Operation—Preferred Embodiment

Preferred Operation of Value Builder Method comprises of (a) a primary account or plurality of primary accounts and (b) a secondary account or avenues of payment to pay the fees, costs, taxes, and expenses of the (a) primary account or accounts. The method in which the (b) secondary account(s) work in tandem with the (a) primary account to pay fees taxes and expenses, whereby preserving the (a) primary account(s) from being depleted from maintenance fees, taxes and other miscellaneous fees. Whereby giving the (a) primary account maximum fluidity and compounded interest over time.

Description

Another embodiment of the Value Builder Method is by means of cash, electronic or wire transfer, direct deposit, credit, and debit, cashier check or by using a single account or plurality of accounts as means.

Operation

Money from a secondary account(s) is used to pay fees, expenses, maintenance, and taxes to benefit a primary account(s), whereby protecting the principal investment. Value Builder Method allows account holders to maintain fluidity within the primary account(s), allowing all of the funds contained in the primary account(s) to be used for its primary, intended purpose.

Conclusions Ramification Scope

Value Builder Method gives individuals, investors, non-profit organizations; government agencies, businesses and corporations more control to manage accounts. Value Builder Method can be used with many types of accounts, including but not limited to Individual Retirement Accounts, Roth Individual Retirement Accounts, Solo 401 Retirement, 401 Retirement Accounts, Roth Solo 401K, Roth 401 Retirement Accounts, 403B Accounts, Keogh pension plans, Sep Individual Retirement Accounts, 529 Education accounts, Simple Individual Retirement Accounts, and other retirement accounts, Health Savings Accounts, Education savings, Money Market, Checking, Savings, and other financial accounts, and a singular or a plurality of accounts, allowing the account holder to retain more of the value of the account(s) for its intended purpose. It's intended purpose may be, but is not limited to use for services, goods, medications, bonds, mutual funds, exchange traded funds, and stocks. Value Builder Method allows account holders more control of accounts. Using Value Builder Method the principal and interest is preserved within the account as well as compounded over time. Tracking of expenses, fees, taxes, and other maintenance costs can be calculated and tracked with ease with Value Builder Method. Value Builder Method allows account holders to maximize use and potential of limited assets.

1) A method using a separate secondary account to pay fees, taxes, and expenses as a means to retain value in a primary retirement, healthcare, education, savings or other financial accounts, comprising:
(a) a retirement, healthcare, savings, investments, education, or other financial account or plurality of primary accounts
(b) a separate secondary account, or means, or plurality of accounts and means, including debit, credit, electronic, checking, cash, wire or electronic transfer, etc.
(c) a means from which associated fees, costs, taxes, maintenance and other related expenses are paid out of secondary account or means, for said primary account whereby retaining the value of said primary account

2) the method of claim 1 wherein a retirement account or plurality of accounts will retain predetermined allowable contributions

3) the method of claim 1 wherein a health savings account or plurality of accounts will retain predetermined allowable contributions

4) the method of claim 1 wherein an investment account or plurality of accounts will retain predetermined allowable contributions

5) the method of claim 1 wherein a roth type account or plurality of roth type accounts will retain predetermined allowable contributions

6) the method of claim 1 wherein an education savings account or plurality of education savings accounts will retain predetermined allowable contributions

7) the method of claim 1 wherein a savings account or plurality of savings accounts will retain predetermined allowable contributions

8) the method of claim 1 wherein a 529 account or plurality of 529 type accounts will retain predetermined allowable contributions

9) the method of claim 1 wherein a 403b account or plurality of 403b type accounts will retain predetermined allowable contributions

10) the method of claim 1 wherein said secondary account is used to pay taxes and fees for a retirement account or plurality of retirement accounts

11) the method of claim 1 wherein said secondary account is used to pay taxes, fees and expenses for maintenance of a Health Savings Account or plurality of Health Savings Accounts

12) the method of claim 1 wherein said secondary account will be used to pay for taxes, fees, and expenses for the maintenance for a roth account or a plurality of Roth accounts

13) the method of claim 1 wherein said secondary account will be used to pay for taxes, fees, and expenses for the maintenance of a health savings account or a plurality of health savings accounts

14) the method of claim 1 wherein said secondary account will be used to pay for taxes, fees, and expenses for the maintenance for an investment account or a plurality of investment accounts

15) the method of claim 1 wherein said secondary account will be used to pay for taxes, fees, and expenses for the maintenance of an education savings account or plurality of education savings accounts

16) the method of claim 1 wherein said secondary account will be used to pay for taxes, fees, and expenses for the maintenance of a 529 account or a plurality of 529 accounts

17) the method of claim 1 wherein said secondary account will be used to pay for taxes, fees, and plurality of expenses for the maintenance of a savings account or plurality of savings accounts

18) the method of claim 1 wherein said secondary account will be used to pay for taxes, fees, and expenses for the maintenance of a 403b account or plurality of 403b accounts

19) the method of claim 1 wherein said primary account will retain maximum value for it's predetermined purpose.
